(19) United States
(12) Patent Application Publication
(10) Pub. No.: US 2014/0286005 A1
(43) Pub. Date: Sep. 25, 2014

(54) Lighting Device Having Optimized Placement of Light-Emitting Elements for Parabolic Fixtures

(71) Applicant: INDEPENDENCE LED LIGHTING, LLC, Devon, PA (US)

(72) Inventors: Charles Attila Szoradi, Wayne, PA (US); Glenn Stewart Baker, Paoli, PA (US)

(73) Assignee: INDEPENDENCE LED LIGHTING, LLC, Devon, PA (US)

(21) Appl. No.: 14/221,013

(22) Filed: Mar. 20, 2014

Related U.S. Application Data
(60) Provisional application No. 61/803,485, filed on Mar. 20, 2013.

(51) Int. Cl. F21K 99/00

(52) U.S. Cl. CPC F21K 9/17
USPC 362/225

(57) ABSTRACT

A lighting fixture comprising an optimized linear module lighting device and a plurality of parabolic fins. The optimized linear module lighting device comprises a substrate comprising at least first, second, and third portions. The optimized linear module lighting device further comprises a plurality of light-emitting elements. A first set of the light-emitting elements are disposed on the first portion of the substrate; a second set of the light-emitting elements are disposed on the second portion of the substrate; and a third set of the light-emitting elements are disposed on the third portion of the substrate. The second set of light-emitting elements is disposed above at least one of the parabolic fins and is less dense than the first and third sets of light-emitting elements.

### CROSS REFERENCE TO RELATED APPLICATION

This application claims the benefit of U.S. Provisional Application No. 61/803,485, entitled “LED Lighting Device Having Optimized LED Placement for Parabolic Fixtures” and filed Mar. 20, 2013, the contents of which application are incorporated herein by reference.

### FIELD OF THE INVENTION

The present invention generally relates to lighting technology and, more specifically, to optimizing the placement of LEDs in LED tubes; LED linear modules, strips, films, and panels; or other sources of lighting to increase total efficacy for mounting in existing parabolic troffer fixtures, for retrofit kits, or for new parabolic troffer fixtures.

### BACKGROUND OF THE INVENTION

Parabolic fixtures are often referred to as fluorescent troffers. As used herein, the term, “parabolic fixture,” is used to describe a fixture that was initially designed to hold fluorescent tubes or fixtures that have a plurality of openings with reflective or non-reflective parabolic fins that frame the openings. Troffer-style fixtures are often used in commercial office and industrial spaces throughout the world. Troffers to date incorporate linear fluorescent light bulbs that span the length of the troffer. Troffers are often mounted to or suspended from ceilings, such as being held by a “T-grid.” Often the troffer may be recessed into the ceiling, with the back side of the troffer, referred to as the troffer pan, protruding into the plenum area above the ceiling a distance of up to six inches or more.

Exemplary conventional parabolic fixtures are illustrated in FIGS. 1 through 6. FIG. 1 illustrates a parabolic fixture 100 having nine openings 110 separated by parabolic fins 115A, 115B, 115C, and 115D. Mounted in the parabolic fixture 100 are three LED tubes 120A, 120B, and 120C, each respectively comprising a plurality of LEDs 125A, 125B, and 125C. The dimensions of the parabolic fixture 100 are 2 ft. by 2 ft. (600 mm by 600 mm).

FIG. 2 illustrates a parabolic fixture 200 having 12 openings 210 separated by parabolic fins 215. Mounted in the parabolic fixture 200 are three LED tubes 220A, 220B, and 220C, each respectively comprising a plurality of LEDs 225A, 225B, and 225C. The dimensions of the parabolic fixture 200 are 2 ft. by 2 ft. (600 mm by 600 mm).

FIG. 3 illustrates a parabolic fixture 300 having 16 openings 310 separated by parabolic fins 315. Mounted in the parabolic fixture 300 are four LED tubes 320A, 320B, 320C, and 320D, each respectively comprising a plurality of LEDs 325A, 325B, 325C, and 325D. The dimensions of the parabolic fixture 300 are 2 ft. by 2 ft. (600 mm by 600 mm).

FIG. 4 illustrates a parabolic fixture 400 having 12 openings 410 separated by parabolic fins 415. Mounted in the parabolic fixture 400 are two LED tubes 420A and 420B, each respectively comprising a plurality of LEDs 425A and 425B. The dimensions of the parabolic fixture 400 are 2 ft. by 4 ft. (600 mm by 1200 mm).

FIG. 5 illustrates a parabolic fixture 500 having 18 openings 510 separated by parabolic fins 515. Mounted in the parabolic fixture 500 are three LED tubes 520A and 520B, each respectively comprising a plurality of LEDs 525A, 525B, and 525C. The dimensions of the parabolic fixture 500 are 2 ft. by 4 ft. (600 mm by 1200 mm).

FIG. 6 illustrates a parabolic fixture 600 having 24 openings 610 separated by parabolic fins 615. Mounted in the parabolic fixture 600 are four LED tubes 620A, 620B, 620C, and 620D, each respectively comprising a plurality of LEDs 625A, 625B, 625C, and 625D. The dimensions of the parabolic fixture 600 are 2 ft. by 4 ft. (600 mm by 1200 mm).

### SUMMARY OF THE INVENTION

In accordance with an aspect of the present invention, there is provided an optimized linear module lighting device. The optimized linear module lighting device comprises a substrate comprising at least first, second, and third portions. The optimized linear module lighting device further comprises a plurality of light-emitting elements. A first set of the light-emitting elements is disposed on the first portion of the substrate; a second set of the light-emitting elements is disposed on the second portion of the substrate; and a third set of the light-emitting elements is disposed on the third portion of the substrate. The second set of light-emitting elements is less dense than the first and second sets of light-emitting elements.

In accordance with another aspect of the present invention, there is provided an optimized LED strip, film or panel device. The optimized LED strip, film or panel device comprises a substrate comprising at least first, second, and third portions. The optimized LED strip, film or panel device further comprises a plurality of light-emitting diodes (LEDs). A first set of the LEDs is disposed on the first portion of the substrate; a second set of the LEDs is disposed on the second portion of the substrate; and a third set of the LEDs is disposed on the third portion of the substrate. The second set of LEDs is less dense than the first and second sets of LEDs. In an exemplary embodiment, the substrate of the optimized LED strip, film or panel device comprises a further portion in which no LEDs are disposed. Such portion corresponds to a fin of a troffer in which the optimized LED strip, film or panel device is configured to be mounted.

In accordance with another aspect of the present invention, there is provided a lighting fixture comprising an optimized linear module lighting device and a plurality of parabolic fins. The optimized linear module lighting device comprises a substrate comprising at least first, second, and third portions. The optimized linear module lighting device further comprises a plurality of light-emitting elements. A first set of the light-emitting elements is disposed on the first portion of the substrate; a second set of the light-emitting elements is disposed on the second portion of the substrate; and a third set of the light-emitting elements is disposed on the third portion of the substrate. The second set of light-emitting elements is disposed above at least one of the parabolic fins and is less dense than the first and third sets of light-emitting elements.

### BRIEF DESCRIPTION OF THE DRAWINGS

For the purpose of illustration, there are shown in the drawings certain embodiments of the present invention. In the drawings, like numerals indicate like elements throughout. It should be understood that the invention is not limited to the precise arrangements, dimensions, and instruments shown. In the drawings:

FIGS. 1-6 illustrate conventional parabolic fixtures in which conventional LED tubes are mounted.

FIG. 7A illustrates a side, cross-sectional view of a conventional fixture in which a conventional LED tube is mounted.

FIG. 7B illustrates a plan view of the LED tube of FIG. 7A.

FIG. 8A illustrates a side, cross-sectional view of a fixture in which an LED tube is mounted, the LED tube comprising a plurality of LEDs disposed in an arrangement optimized for lighting efficacy, in accordance with an exemplary embodiment of the present invention.

FIG. 8B illustrates a plan view of the LED tube of FIG. 8A, in accordance with an exemplary embodiment of the present invention.

FIG. 9 illustrates a plan view of a fixture in which a plurality of light panels is disposed, in accordance with an exemplary embodiment of the present invention.

FIG. 10 illustrates a plan view of a fixture in which a plurality of single high output LEDs or densely clustered LED is disposed, in accordance with an exemplary embodiment of the present invention.

### DETAILED DESCRIPTION OF THE INVENTION

Reference to the drawings illustrating various views of exemplary embodiments of the present invention is now made. In the drawings and the description of the drawings herein, certain terminology is used for convenience only and is not to be taken as limiting the embodiments of the present invention. Furthermore, in the drawings and the description below, like numerals indicate like elements throughout.

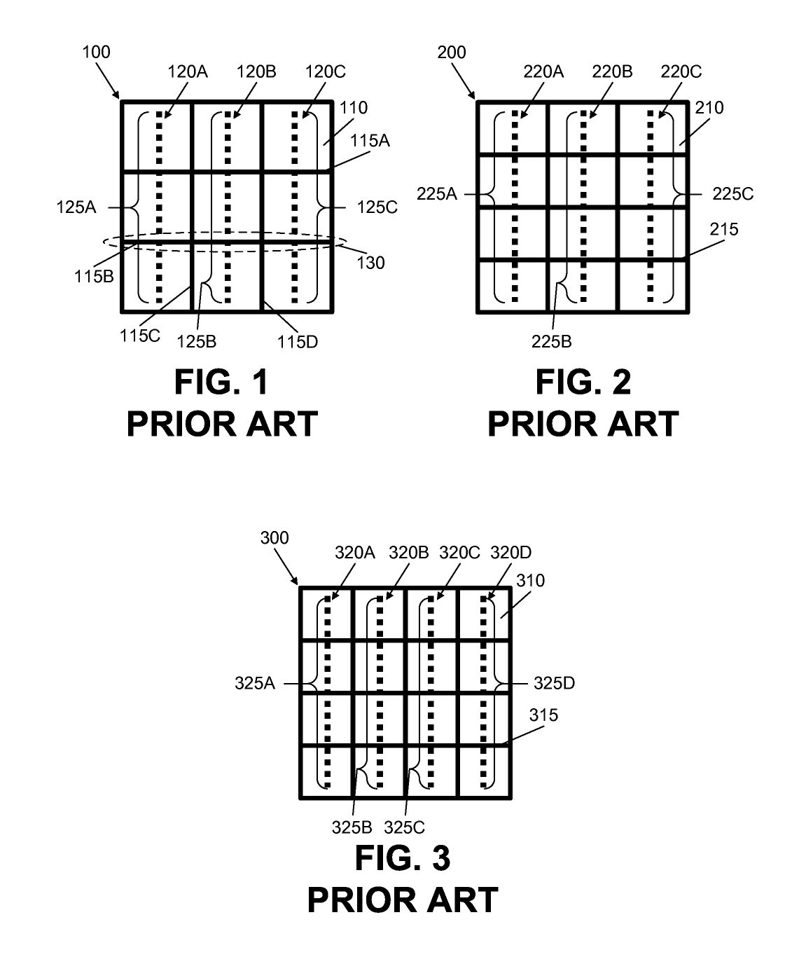

Efficacy is the total fixture efficiency to deliver the most light to desired areas. In a conventional parabolic fixture, such as any of fixtures 100 through 600, the parabolic fins 115 through 615 are typically wider on the side of the fixture 100-600 mounted to a ceiling (the top ceiling side) than on the other side of the fixture 100-600. Thus, the parabolic fins 115 through 615 are tapered, and the ceiling side of the fins 115 through 615 block the light emitted by the LEDs 125 through 625 of the LED tubes 120 through 620. An exemplary region of the LEDs 125A, 125B, and 125C of the LED tubes 120A, 120B, and 125C blocked by the fin 115B is indicated in FIG. 1 as region 130. It is to be understood that a similar region of the LEDs 125A, 125B, and 125C of the LED tubes 120A, 120B, and 125C is also blocked by the fin 115A and that similar regions of the LEDs 225, 325, 425, 525, and 625 of respective LED tubes 220, 320, 420, 520, and 620 are blocked by the horizontal fins 215, 315, 415, 515, and 615 of the fixtures 200, 300, 400, 500, and 600.

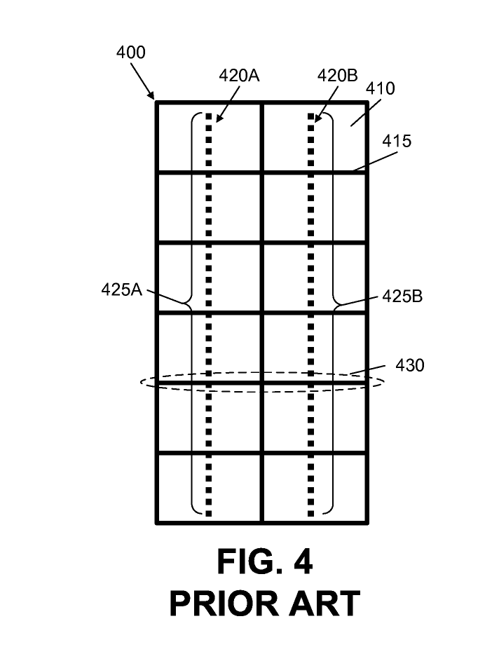

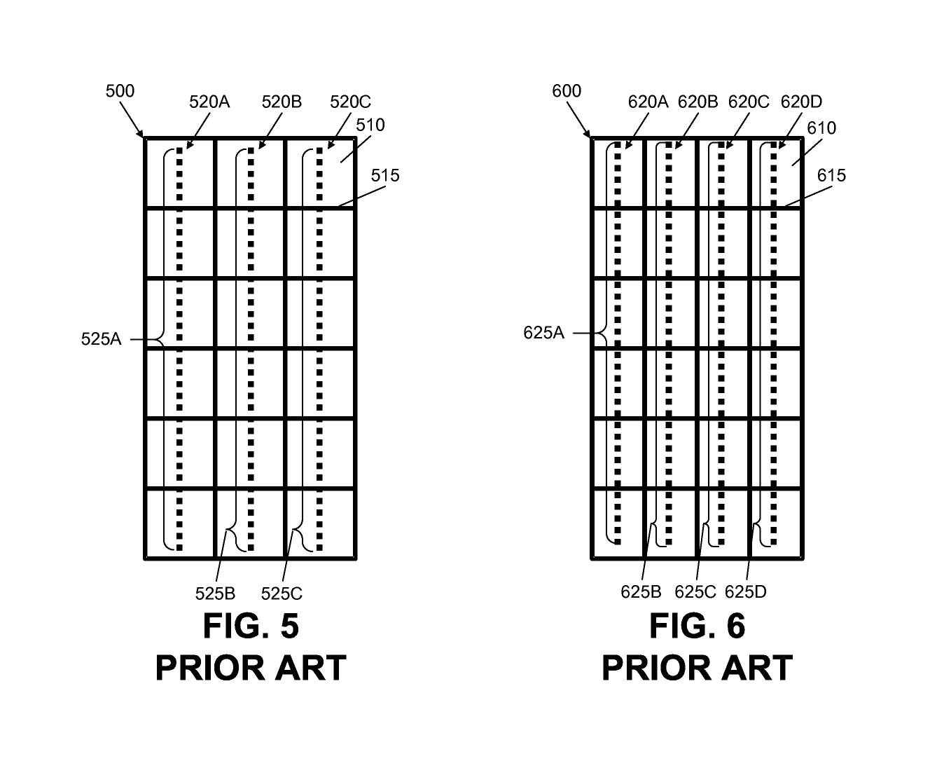

Referring now to FIG. 7A, there is illustrated a side view of a cross section of a conventional fixture 700 in which a conventional LED tube 720A comprising a plurality of LEDs 725A is mounted in a conventional arrangement. Illustrated are three openings 710A through 710C in the fixture 700 separated by parabolic fins 715A and 715B. As seen from the cross section, the fins 715A and 715B are wider at the side nearest to the LED tube 720A compared to the side furthest from the LED tube 720A. FIG. 7A illustrates a region 730A of the LEDs 725A located above the fin 715A and a region 730B of the LEDs 725A located above the fin 715B.

Illustrated in FIG. 7B is a plan view of the LED tube 720A as seen from the illumination area below the conventional fixture 700. The LED tube 720A includes LEDs 725A mounted on all portions thereof, including portions 721A.1, 721A.2, 722A.1, 722A.2, and 722A.3 illustrated in FIG. 7B. Portions 721A.2 and 721A.2 of the LED tube 720A illustrated in FIG. 7A correspond to regions 730A and 730B illustrated in FIG. 7A.

Referring to FIGS. 7A and 7B together, because light 716A and 716B emitted by the LEDs 725A in the portions 721A.1 and 721A.2 is reflected by upper surfaces 717A and 717B of respective fins 715A and 715B, the efficacy of the fixture 700 is negatively affected. Thus, the placement of the LEDs 725A on the LED tube 720A is not optimized.

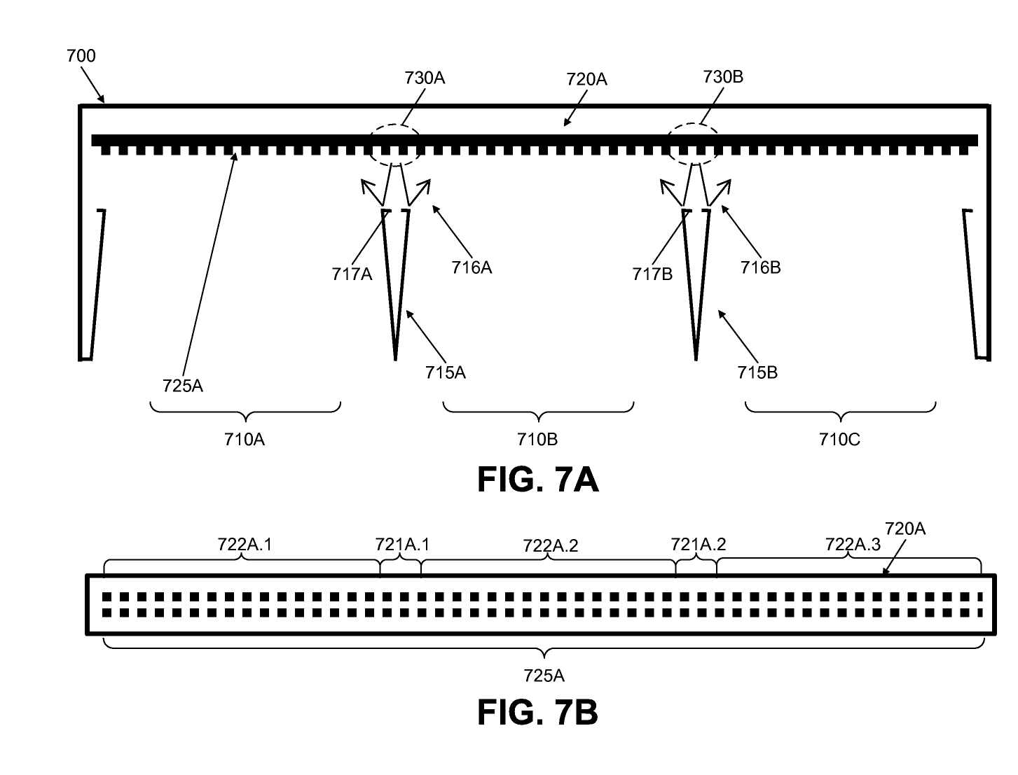

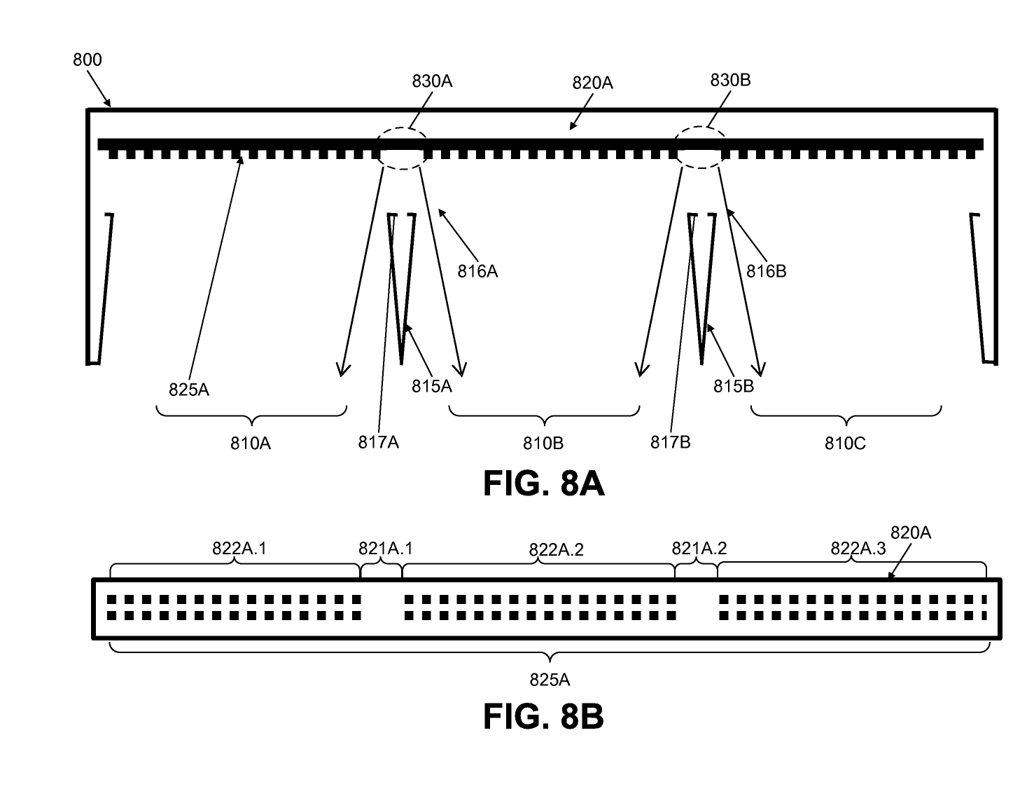

Illustrated in FIG. 8A is a side view of a cross section of a fixture, generally designated as 800, in which linear module lighting device 820A, specifically an LED tube 820A, is mounted therein, in accordance with an exemplary embodiment of the present invention. FIG. 8B illustrates a plan view of the LED tube 820A as seen from the illumination area below the fixture 800. The fixture 800 may be a new fixture or a retrofitted fixture.

Referring to FIGS. 8A and 8B together, the fixture 800 further comprises three openings 810A, 810B, and 810C separated by parabolic fins 815A and 815B. As seen from the cross section, the fins 815A and 815B are wider at the side nearest to the LED tube 820A compared to the side furthest from the LED tube 820A. FIG. 8A illustrates a region 830A of the LED tube 820A located above the fin 815A and a region 830B of the LED tube 820A located above the fin 815B.

The LED tube 820A comprises a plurality of LEDs 825A disposed on a substrate 805. The LEDs 825A are disposed in the portions 822A.1, 822A.2, and 822A.3 of the substrate 805 of the LED tube 820A corresponding to the openings 810A, 810B, and 810C, respectively. No LEDs 825A are disposed in the portions 821A.1 and 821A.2 of the LED tube 820A corresponding to the upper surfaces 817A and 817B of the fins 815A and 815B, whereas there are four LEDs in each of the portions 721A.1 and 721A.2 of the LED tube 720A. Thus, light 816A and 816B emitted by the LEDs 825A is not reflected (or minimally reflected) back toward the LED tube 820A. By reducing the number of LEDs 825A, changing the spacing of the LEDs 825A, or eliminating them altogether (as illustrated in FIG. 8B) directly above the parabolic fins 815A and 815B in the portions 821A.1 and 821A.2, the efficacy of the LED tube 820A in the fixture 800 is increased over the LED tube 720A in the fixture 700.

It is to be understood in other exemplary embodiments of the optimized LED tube 820A that there may be one, two, or three LEDs 825A remaining in each of the portions 821A.1 and 821A.2 depending on output requirements of the LED tube 820A. In each optimized case, the portions 821A.1 and 821A.2 have fewer LEDs 825A, or more specifically a lower LED density, than the other areas 822A.1, 822A.2, and 822A.3. This approach to placing the LEDs 825A applies for single or triple rows of diodes (or any number of rows of diodes) in addition to the double rows shown in FIG. 8B.

In exemplary embodiments of the fixture 800, the fins 815A, 815B each have a width of ¾ in. or 1 in., i.e., the upper surface 817A, 817B of either fin 815A, 815B has a width of either ¾ in. or 1 in. In such embodiments, the width of each of the portions 821A.1 and 821A.2 is, respectively ¾ in. or 1 in. Thus, the ratio of the width of each of the portions 821A.1 and 821A.2 to the width of the upper surface 817A, 817B of either fin 815A, 815B is 1:1. Such ratio may vary between 1:1 and 2:1, depending on the beam angle of the LED used, for example. For example, in another exemplary embodiment the width of each of the portions 821A.1 and 821A.2 is 1.5 in., and the width of the upper surface 817A, 817B of either fin 815A, 815B is 1 in. In yet another exemplary embodiment the width of each of the portions 821A.1 and 821A.2 is 2 in., and the width of the upper surface 817A, 817B of either fin 815A, 815B is 1 in.

It is to be understood that different fixtures may have fins having upper surfaces having widths other than ¾ in. or 1 in. In such embodiments, the ratio of the width of each of the portions 821A.1 and 821A.2 to the width of the upper surface of the fins in such fixtures still may be anywhere from 1:1 to 2:1. Further, it is to be understood that not all fixtures have fins having upper surfaces that have uniform widths. Some fixtures have a combination of upper widths of fins. Thus, the width of each of the portions 821A.1 and 821A.2 may differ as the width of the upper surface of the corresponding fin differs from that of other fins in the fixture. The ratio of each portion 821A.1, 821A.2 to the width of the upper surface of the corresponding fin, however, is still between 1:1 and 2:1 depending on the beam angle of the LED used, for example.

The decrease in wasted light resulting from reducing or omitting LEDs in one portion 821A.1, for example, is marginal relative to the total light output from the fixture 800, but the decrease in wasted light is compounded by the number and type of fins in the fixture 800, above which corresponding portions of LED tubes have reduced numbers of LEDs or no LEDs, in accordance with exemplary embodiments of the present invention. Current LED manufacturers provide a uniform distribution of diodes across an LED tube or retrofit light panel. By placing the diodes in a non-uniform position to account for the parabolic fins 815A and 815B, the LED fixture 800 retrofitted with LED tubes 820A requires less wattage to deliver the same useable amount of light or may use the same amount of electricity to deliver an increased level of useable light.

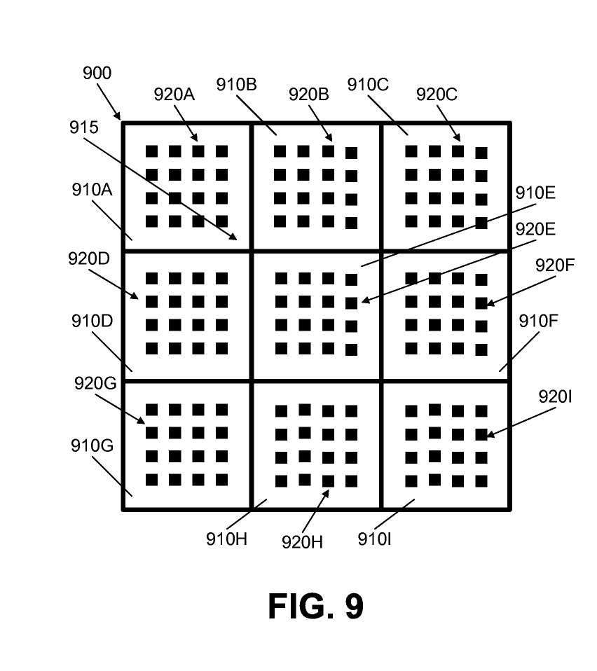

The optimized LED placement for parabolic fixtures described herein is applicable beyond LED tubes to include insert light panels that mount to the underside of a fixture housing. Illustrated in FIG. 9 is a plan view of a fixture 900, in accordance with an exemplary embodiment of the present invention. The fixture 900 comprises a plurality of light panels 920A-I disposed in openings 910A-I between fins 915. The size and placement of the light panels 920A-I are optimized for openings 910A-I of the fixture 900. The gaps between adjacent light panels 920A-I may be sized using the techniques described above for LED tube 820A.

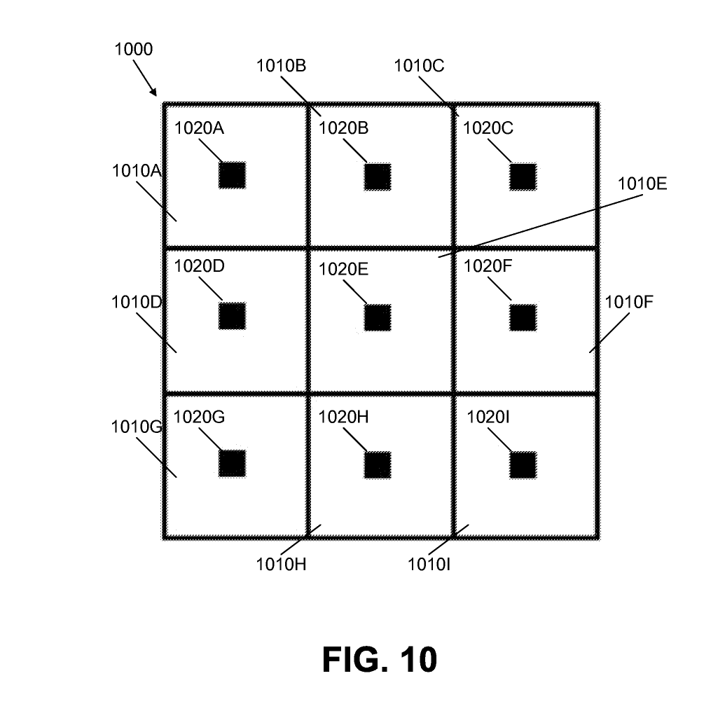

FIG. 10 illustrates a plan view, as seen from the illumination area below, of a fixture 1000 comprising single high output LEDs or densely clustered LEDs 1020A-I disposed in respective openings 1010A-I, in accordance with an exemplary embodiment of the present invention. The high output LEDs or densely clustered LEDs 1020A-I are spaced between the parabolic fins of the fixture.

It is to be understood that the LED tube 820A, the light panels 920A-I, and the high output LEDs or densely clustered LEDs 1020A-I may be used with many different size fixtures, such a 2 ft. by 2 ft. troffer, such as illustrated in FIGS. 1-3, in a 2 ft. by 4 ft. troffer, such as illustrated in FIGS. 4-6, or any other suitably dimensioned troffers.

It is to be understood that the exemplary embodiments of the present invention described herein are not limited to using LED tubes, light panels, high output LEDs, or densely clustered LEDs. Other exemplary embodiments of the present invention comprising linear lighting modules using any known light-emitting elements, laminated film applications or other substrates such as diodes on printed circuit boards, metal core boards, FR4 boards, metal strips, or diodes directly applied to heat sinks, with placement of light-emitting elements optimized as described above, are contemplated. Exemplary substrates and LED lighting devices that may benefit from optimized LED placement using the techniques described above are described in further detail in U.S. application Ser. No. 13/188,029 of Szoradi et al., filed Jul. 21, 2011 and entitled, “Light Engine Device with Direct to Linear System Driver,” the contents of which are incorporated herein by reference in their entirety.

These and other advantages of the present invention will be apparent to those skilled in the art from the foregoing specification. Accordingly, it is to be recognized by those skilled in the art that changes or modifications may be made to the above-described embodiments without departing from the broad inventive concepts of the invention. It is to be understood that this invention is not limited to the particular embodiments described herein, but is intended to include all changes and modifications that are within the scope and spirit of the invention.

What is claimed is:

1. An optimized linear module lighting device comprising:
a substrate comprising at least first, second, and third portions; and
a plurality of light-emitting elements, wherein a first set of the light-emitting elements is disposed on the first portion of the substrate, a second set of the light-emitting elements is disposed on the second portion of the substrate, and a third set of the light-emitting elements is disposed on the third portion of the substrate,
wherein the second set of light-emitting elements is less dense than the first and second sets of light-emitting elements.

2. The optimized linear module lighting device of claim 1, wherein no light-emitting elements are disposed on the second portion of the substrate.

3. The optimized linear module lighting device of claim 2, wherein a ratio of a width of the further portion to a width of a fin of a troffer in which the optimized linear module lighting device is configured to be mounted is 1:1.

4. The optimized linear module lighting device of claim 2, wherein a ratio of a width of the further portion to a width of a fin of a troffer in which the optimized linear module lighting device is configured to be mounted is 2:1.

5. The optimized linear module lighting device of claim 1, wherein the light-emitting elements are LEDs.

6. An optimized LED strip, film or panel device comprising:
a substrate comprising at least first, second, and third portions; and
a plurality of light-emitting diodes (LEDs), wherein a first set of the LEDs is disposed on the first portion of the substrate, a second set of the LEDs is disposed on the second portion of the substrate, and a third set of the LEDs is disposed on the third portion of the substrate,
wherein the second set of LEDs is less dense than the first and second sets of LEDs.

7. The optimized LED strip, film or panel device of claim 6, wherein no LEDs are disposed on the second portion of the substrate.

8. The optimized LED strip, film or panel device of claim 7, wherein a ratio of a width of the further portion to a width of a fin of a troffer in which the optimized LED strip, film or panel device is configured to be mounted is 1:1.

9. The optimized LED strip, film or panel device of claim 7, wherein a ratio of a width of the further portion to a width of a fin of a troffer in which the optimized LED strip, film or panel device is configured to be mounted is 2:1.

10. A lighting fixture comprising:
optimized linear module lighting device comprising:
a substrate comprising at least first, second, and third portions; and
a plurality of light-emitting elements, wherein a first set of the light-emitting elements is disposed on the first portion of the substrate, a second set of the light-emitting elements is disposed on the second portion of the substrate, and a third set of the light-emitting elements is disposed on the third portion of the substrate; and
a plurality of parabolic fins,
wherein the second set of light-emitting elements is disposed above at least one of the parabolic fins, and
wherein the second set of light-emitting elements is less dense than the first and third sets of light-emitting elements.

11. The lighting fixture of claim 10, wherein no light-emitting elements are disposed on the second portion of the substrate.

12. The lighting fixture of claim 11, wherein a ratio of a width of the further portion to the at least one of the parabolic fins is 1:1.

13. The lighting fixture of claim 11, wherein a ratio of a width of the further portion to the at least one of the parabolic fins is 2:1.

14. The lighting fixture of claim 10, wherein the light-emitting elements are LEDs.
